(19) United States
(12) Patent Application Publication
(10) Pub. No.: US 2026/0127600 A1
(43) Pub. Date: May 7, 2026

(54) PROVIDING VIRTUAL IDENTIFIERS TO MOBILE DEVICES

(71) Applicant: Capital One Services, LLC, McLean, VA (US)

(72) Inventors: Ian OROURKE, Washington, DC (US); Timothy E. EMERSON, Ashburn, VA (US); Walker MARSH, Brooklyn, NY (US)

(21) Appl. No.: 18/938,743

(22) Filed: Nov. 6, 2024

(51) Int. Cl. G06Q 20/40

(52) U.S. Cl. CPC G06Q 20/4014

(57) ABSTRACT

In some implementations, an identifier manager may receive, from a user device, a request for a virtual identifier, the request indicating an intended user for the virtual identifier and a permanent identifier to be associated with the virtual identifier. The identifier manager may receive, from the user device, an indication of a set of restrictions for the virtual identifier. The identifier manager may generate the virtual identifier in response to the request. The identifier manager may transmit, to an account manager, the virtual identifier for association with the permanent identifier and the set of restrictions. The identifier manager may determine a mobile receiving device based on the intended user. The identifier manager may verify a user of the mobile receiving device. The identifier manager may transmit, to an application executed by the mobile receiving device, the virtual identifier in response to verifying the user.

### BACKGROUND

To improve security in a computerized system, virtual identifiers may be used in place of permanent identifiers. For example, a virtual card number (VCN) may be used in place of a payment account number (PAN). Tokenizing the PAN into the VCN improves security because the VCN may be replaced, if compromised, more easily than the PAN.

### SUMMARY

Some implementations described herein relate to a system for providing a virtual identifier to a mobile receiving device. The system may include one or more memories and one or more processors communicatively coupled to the one or more memories. The one or more processors may be configured to receive, from a user device, a request for the virtual identifier, the request indicating an intended user for the virtual identifier and a permanent identifier to be associated with the virtual identifier. The one or more processors may be configured to receive, from the user device, an indication of a set of restrictions for the virtual identifier. The one or more processors may be configured to generate the virtual identifier in response to the request. The one or more processors may be configured to transmit, to an account manager, the virtual identifier for association with the permanent identifier and the set of restrictions. The one or more processors may be configured to determine the mobile receiving device based on the intended user. The one or more processors may be configured to transmit, to the mobile receiving device, a hyperlink associated with the virtual identifier. The one or more processors may be configured to receive, from the mobile receiving device and over a computer network, an application programming interface (API) call using the hyperlink. The one or more processors may be configured to verify a user of the mobile receiving device using a set of credentials received with the API call. The one or more processors may be configured to transmit, to an application executed by the mobile receiving device and over the computer network, the virtual identifier in response to verifying the user.

Some implementations described herein relate to a method of providing a virtual identifier to a mobile receiving device. The method may include receiving, from a user device, a request for the virtual identifier, the request indicating an intended user for the virtual identifier and a permanent identifier to be associated with the virtual identifier. The method may include receiving, from the user device, an indication of a set of restrictions for the virtual identifier. The method may include generating, by an identifier manager, the virtual identifier in response to the request. The method may include transmitting, to an account manager, the virtual identifier for association with the permanent identifier and the set of restrictions. The method may include determining, by the identifier manager, the mobile receiving device based on the intended user. The method may include verifying, by the identifier manager, a user of the mobile receiving device. The method may include transmitting, to an application executed by the mobile receiving device, the virtual identifier in response to verifying the user.

Some implementations described herein relate to a non-transitory computer-readable medium that stores a set of instructions for requesting that a virtual identifier be sent. The set of instructions, when executed by one or more processors of a device, may cause the device to receive instructions for a first user interface (UI) that includes at least one first input element for indicating a target user. The set of instructions, when executed by one or more processors of the device, may cause the device to output the first UI. The set of instructions, when executed by one or more processors of the device, may cause the device to receive, using the first UI, an indication of the target user. The set of instructions, when executed by one or more processors of the device, may cause the device to receive instructions for a second UI that includes at least one second input element for indicating a restriction. The set of instructions, when executed by one or more processors of the device, may cause the device to output the second UI. The set of instructions, when executed by one or more processors of the device, may cause the device to receive, using the second UI, an indication of the restriction. The set of instructions, when executed by one or more processors of the device, may cause the device to transmit a request to provide the virtual identifier, with the restriction, to the target user.

### BRIEF DESCRIPTION OF THE DRAWINGS

FIGS. 1A-1F are diagrams of an example implementation relating to providing virtual identifiers to mobile devices, in accordance with some embodiments of the present disclosure.

FIGS. 2A-2D are diagrams of example UIs relating to requesting a virtual identifier, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to providing virtual identifiers to mobile devices, in accordance with some embodiments of the present disclosure.

FIG. 6 is a flowchart of an example process relating to requesting a virtual identifier, in accordance with some embodiments of the present disclosure.

### DETAILED DESCRIPTION

The following detailed description of example implementations refers to the accompanying drawings. The same reference numbers in different drawings may identify the same or similar elements.

To improve security in a computerized system, virtual identifiers may be used in place of permanent identifiers. For example, a VCN may be used in place of a PAN. Tokenizing the PAN into the VCN improves security because the VCN may be replaced, if compromised, more easily than the PAN. As a result, computer resources are conserved.

In order to request a VCN, a user generally uses an automated phone system or a website to trigger generation of the VCN. However, the automated phone system is associated with increased latency in submitting the request, and the website generally lacks flexibility (e.g., by only offering an ability to add authorized users and not generate temporary VCNs).

Additionally, the user generally has to wait for a physical card (with the VCN) to give to the authorized user or has to unsecurely transfer the VCN (e.g., via a text message or an email message, among other examples). As a result, security is reduced. Additionally, computer resources are wasted on undoing any fraudulent events (e.g., transactions) performed using the VCN.

Some implementations described herein enable automatic transfer of a virtual identifier to a mobile receiving device after generation of the virtual identifier. As a result, latency in requesting the virtual identifier is reduced, and security is improved because a target user may be verified using the mobile receiving device before the virtual identifier is transferred. Therefore, computer resources are conserved that otherwise would have been spent in undoing any fraudulent events (e.g., transactions) performed using the virtual identifier.

Additionally, some implementations described herein enable UIs for triggering generation of a virtual identifier and transfer of the virtual identifier to a mobile receiving device. As a result, latency in requesting the virtual identifier is reduced, and flexibility is increased (e.g., over websites that only offer an ability to add an authorized user and not generate a temporary virtual identifier).

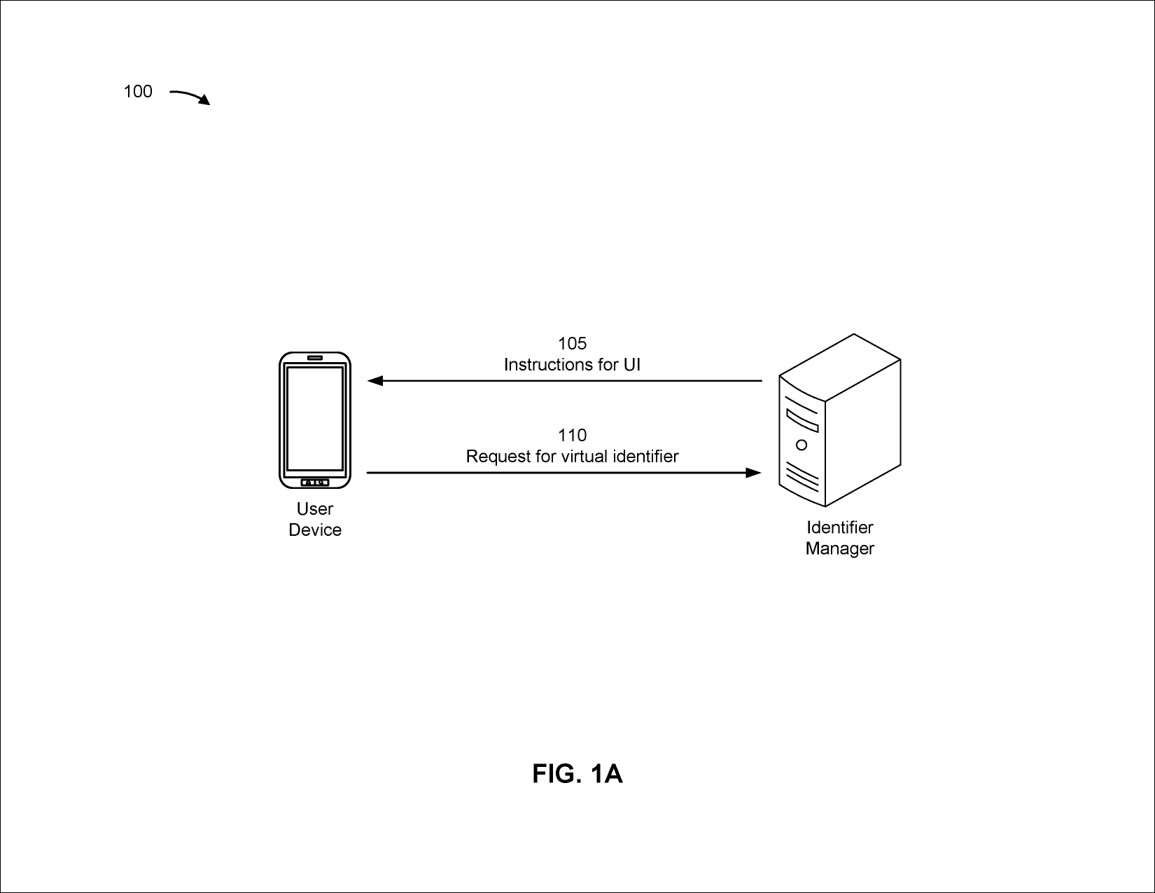

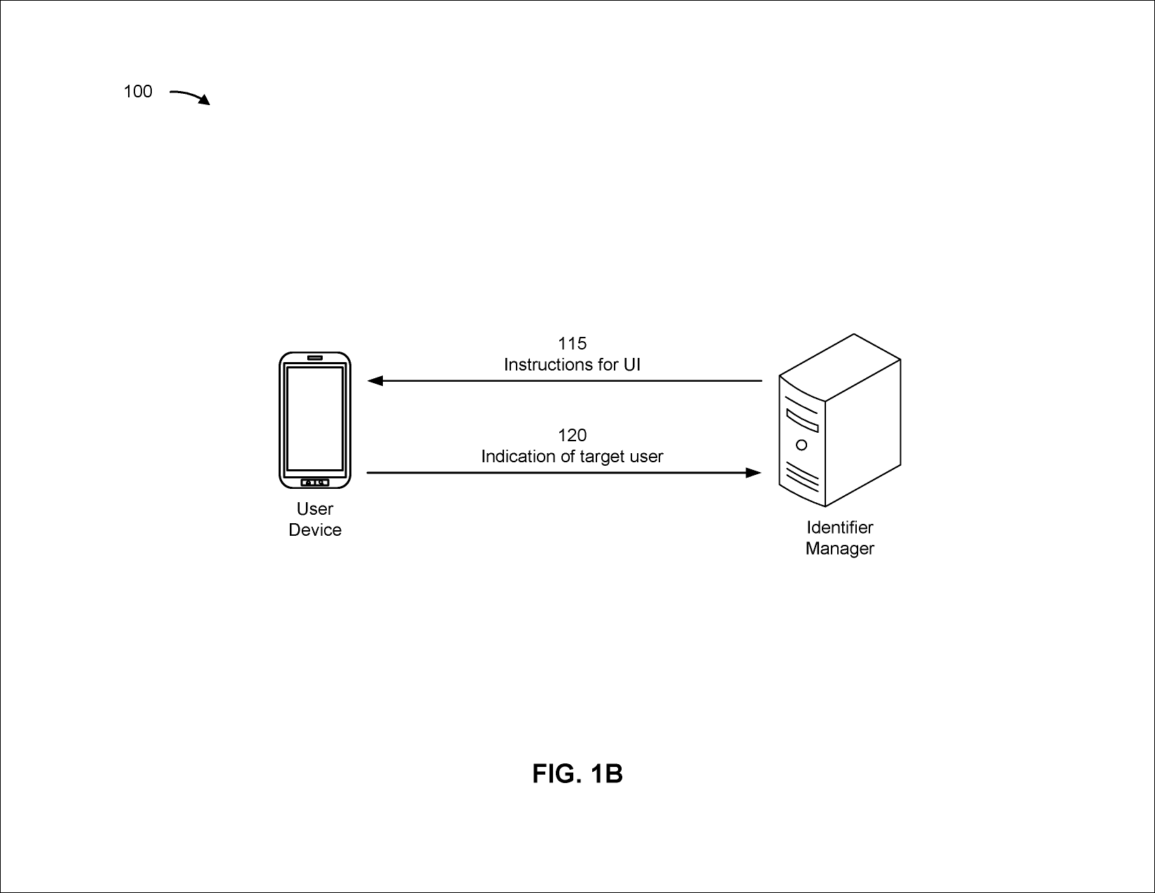

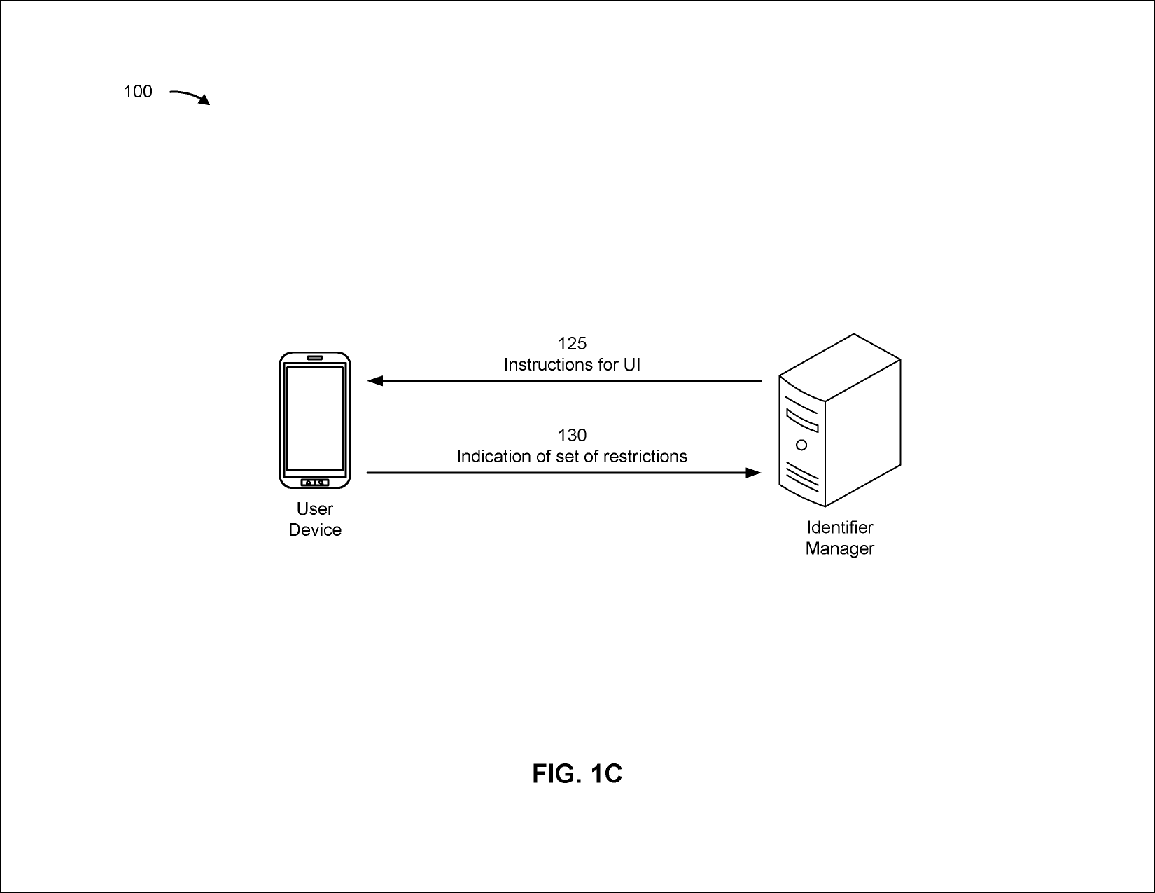

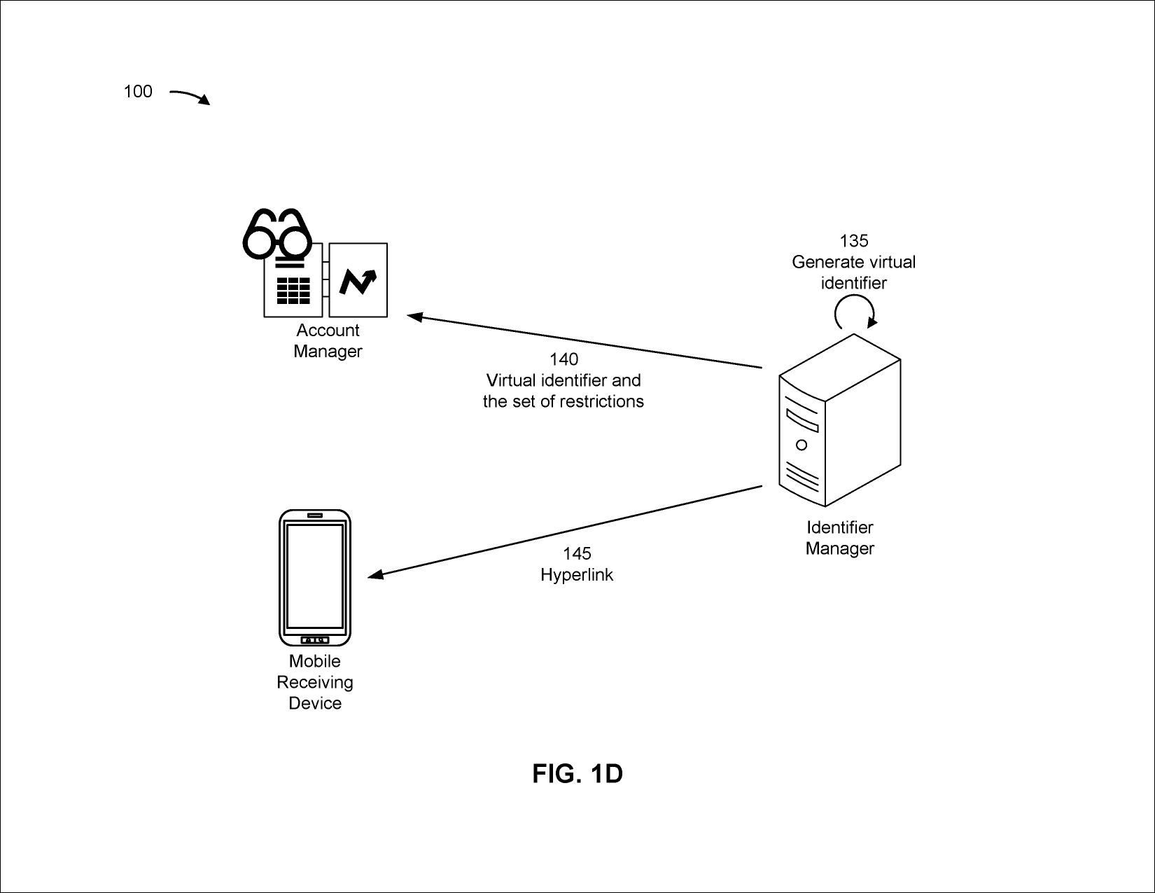

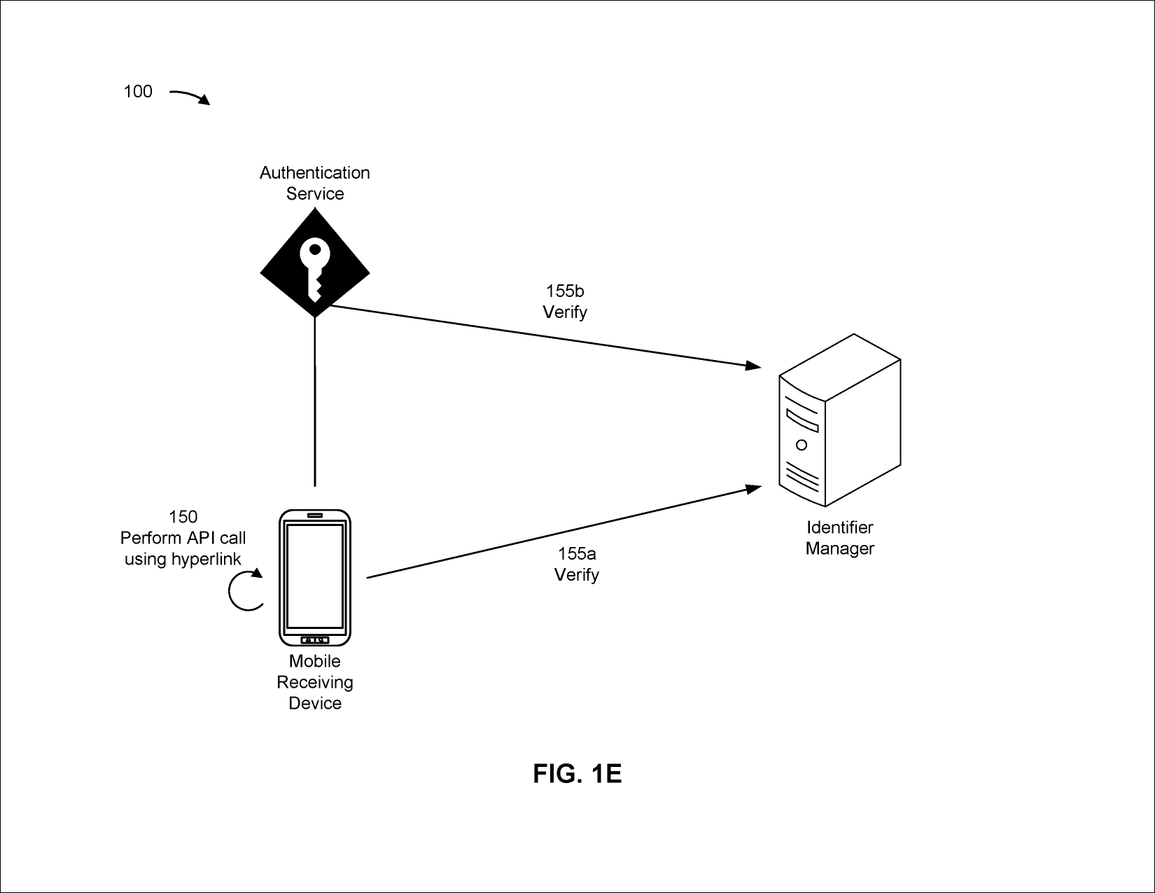

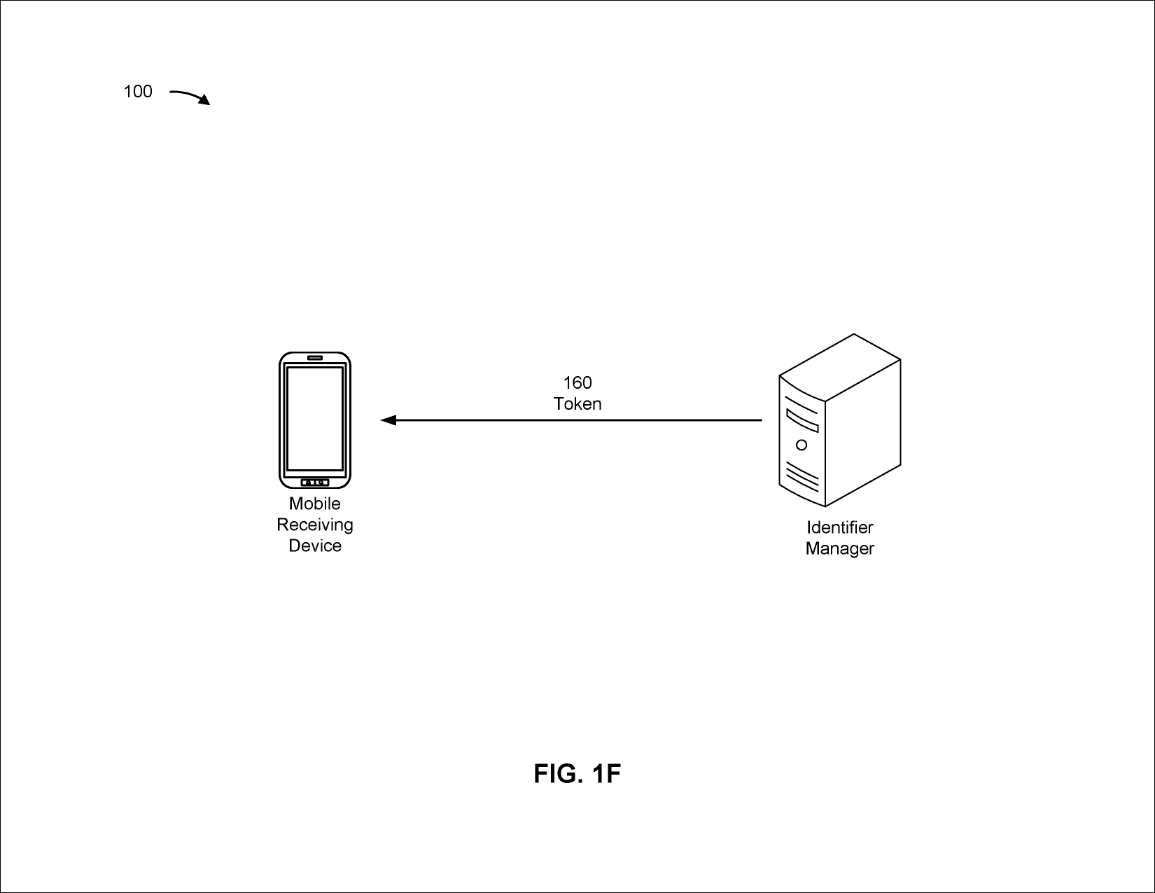

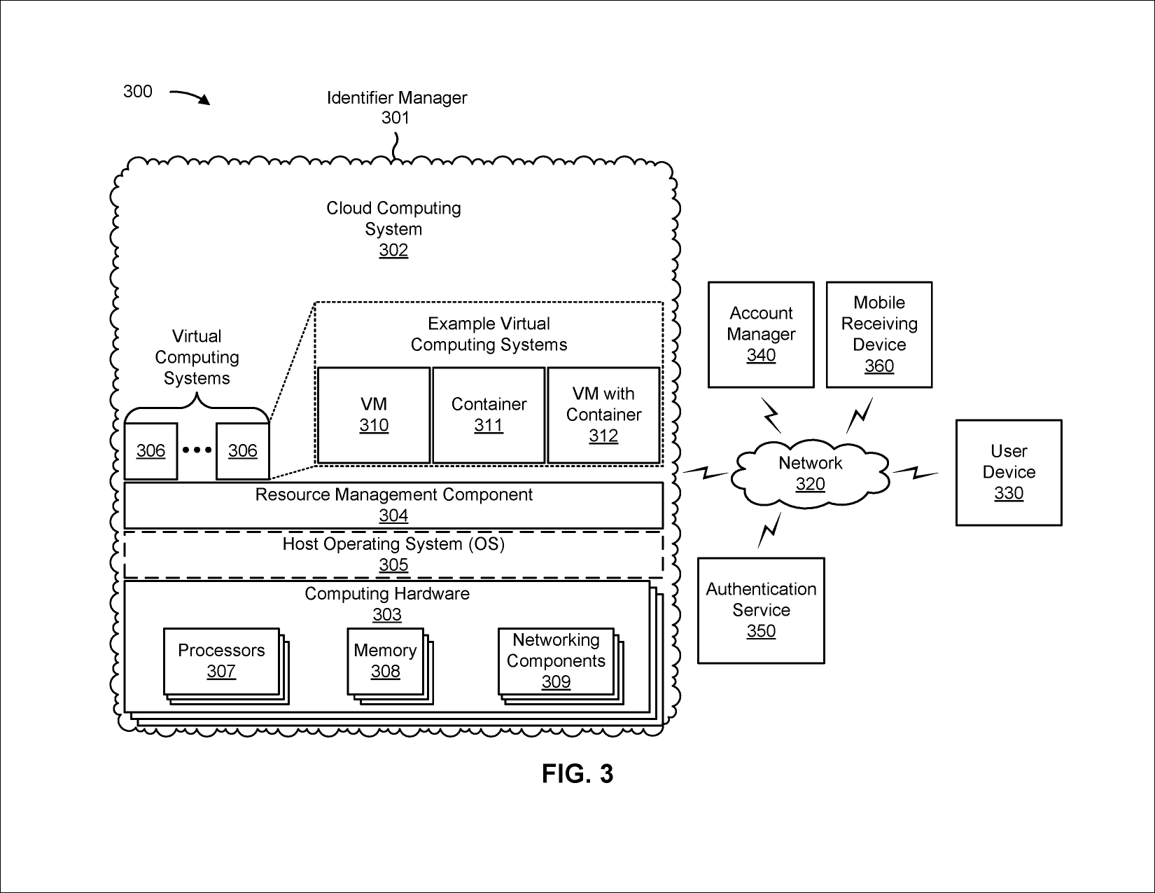

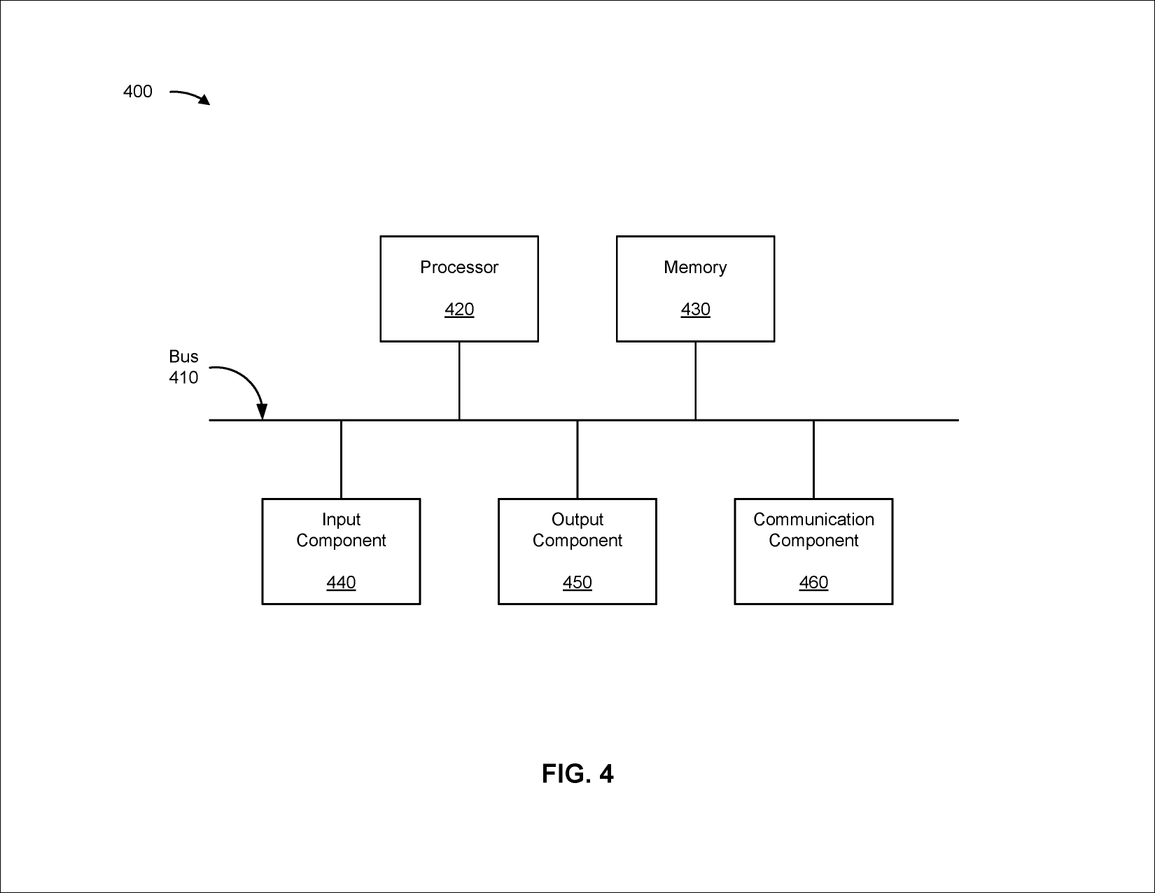

FIGS. 1A-1F are diagrams of an example 100 associated with providing virtual identifiers to mobile devices. As shown in FIGS. 1A-1F, example 100 includes a user device, an identifier manager, an account manager, a mobile receiving device, and an authentication service. These devices are described in more detail in connection with FIGS. 3 and 4.

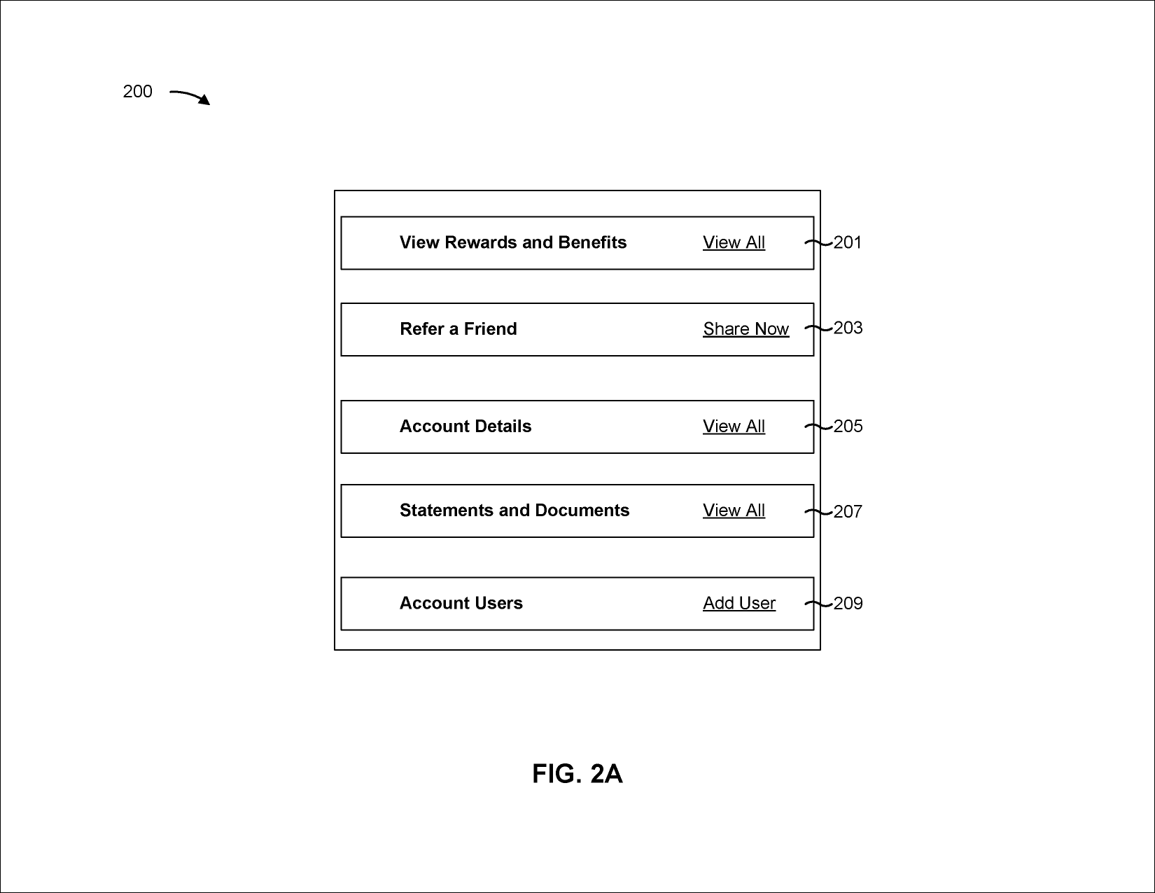

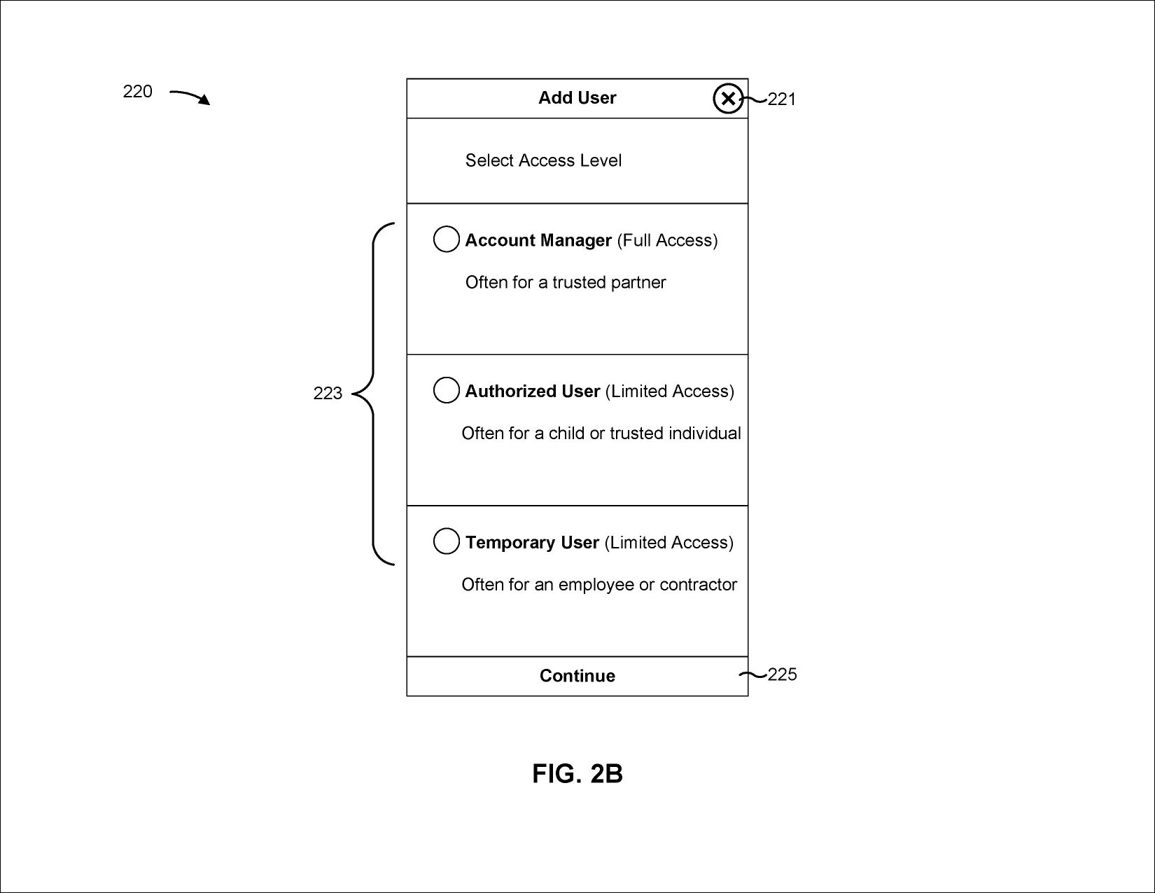

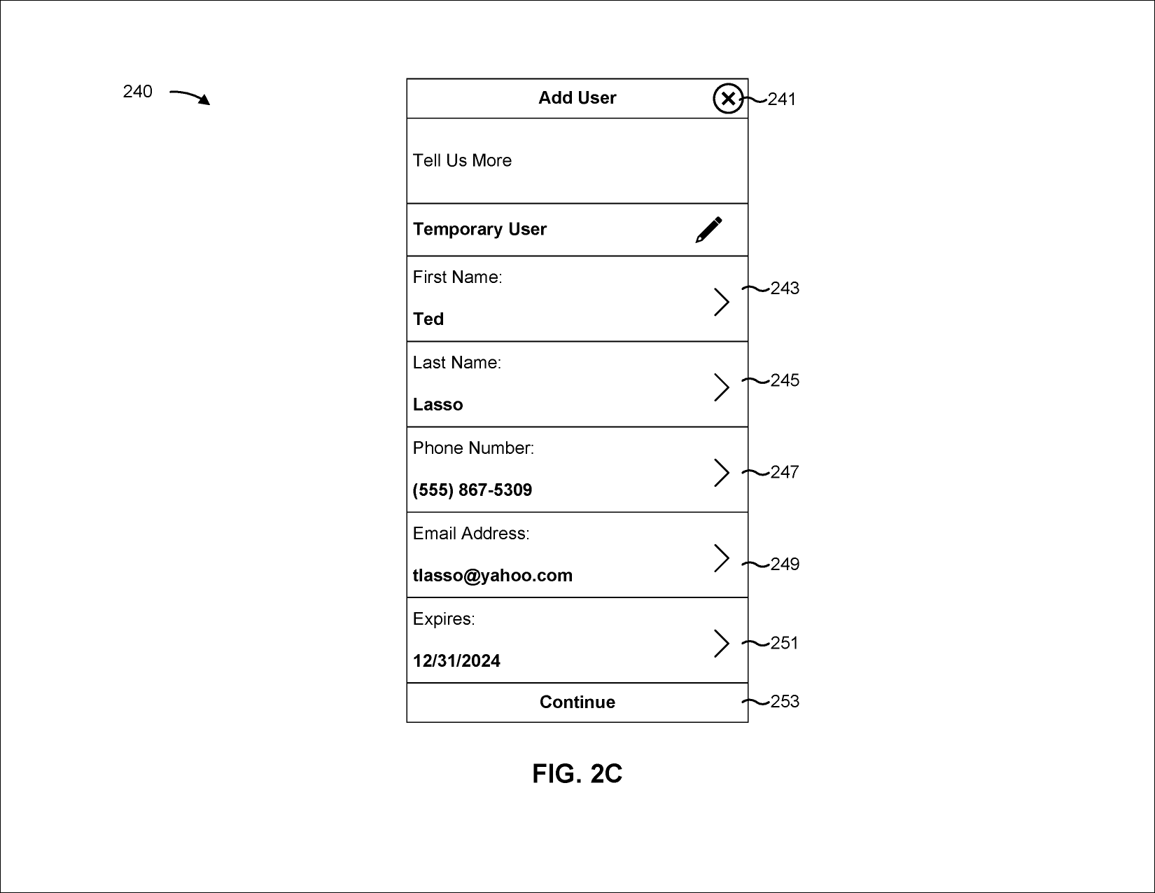

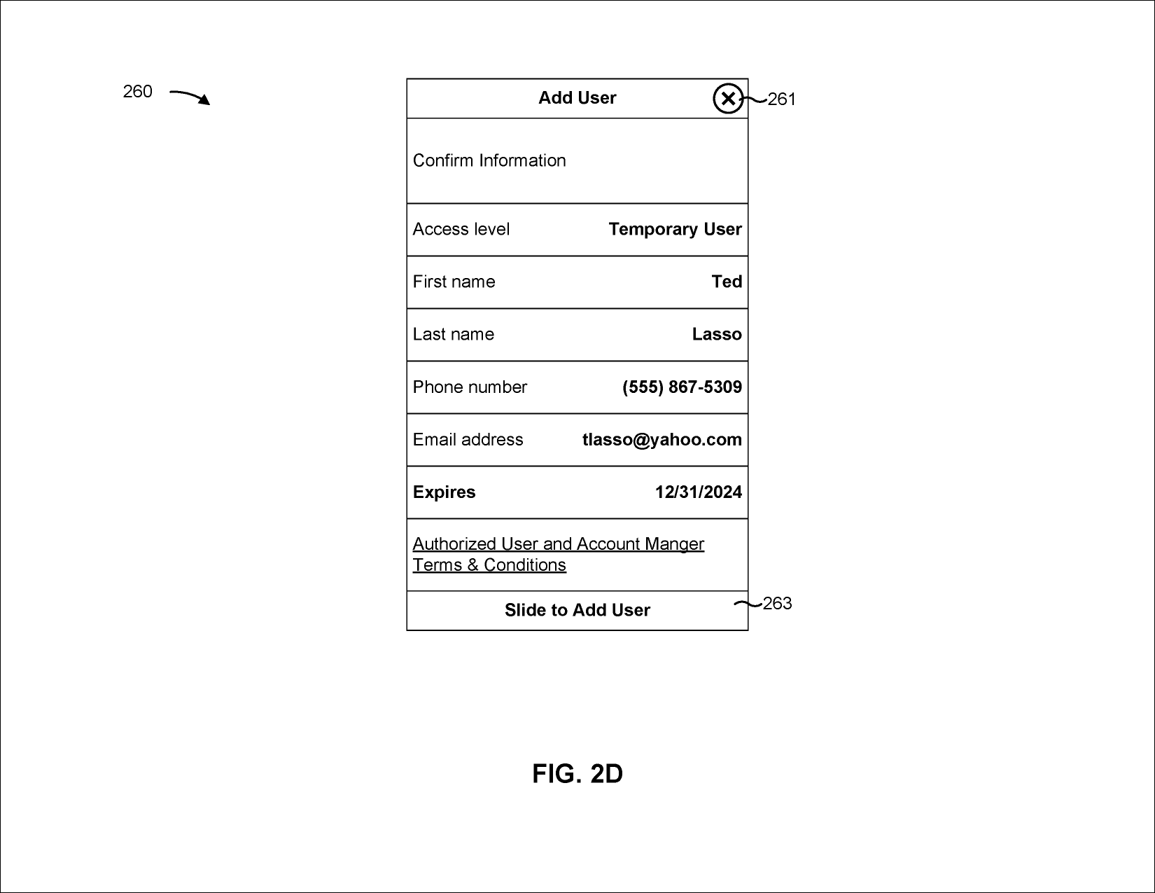

As shown in FIG. 1A and by reference number 105, the identifier manager may transmit, and the user device may receive, instructions for a UI. The UI may be as described in connection with FIG. 2A and/or FIG. 2B. Accordingly, the user device may receive input (e.g., from a user of the user device), using the UI, that initiates a process for providing a virtual identifier. For example, the user may interact with a link (e.g., as described in connection with FIG. 2A) and/or a button (e.g., as described in connection with FIG. 2B) to initiate the process. Therefore, the user device may transmit, and the identifier manager may receive, a request for the virtual identifier (to be associated with a permanent identifier), as shown by reference number 110. The request may include a hypertext transfer protocol (HTTP) request and/or an API call. The request may include an indication of the permanent identifier.

In some implementations, the user device may transmit, and the identifier manager may receive, a set of credentials (e.g., associated with the permanent identifier). Accordingly, the identifier manager may verify the set of credentials before processing the request from the user device. In some implementations, the user device may include the set of credentials with the request. Alternatively, the user device may transmit the set of credentials, the identifier manager may verify the set of credentials, and the user device may receive instructions for the UI in response to (the identifier manager verifying) the set of credentials. Alternatively, the user device may transmit the request, the identifier manager may prompt the user device for the set of credentials in response to the request, the user device may transmit the set of credentials in response to the prompt, and the identifier manager may process the request in response to verifying the set of credentials.

As shown in FIG. 1B and by reference number 115, the identifier manager may transmit, and the user device may receive, instructions for a UI that includes a first input element (e.g., at least one first input element) for indicating a target user. The identifier manager may transmit, and the user device may receive, the instructions for the UI in response to the request received in connection with reference number 105. The UI may be as described in connection with FIG. 2C. Accordingly, the user device may receive an indication of the target user (e.g., from the user of the user device) using the UI. For example, the user may interact with a text box (e.g., as described in connection with FIG. 2C) to input the indication of the target user (e.g., an email address and/or a phone number, among other examples). Therefore, the user device may transmit, and the identifier manager may receive, the indication of the target user, as shown by reference number 120. The indication may be included in an HTTP message and/or as an argument to an API call.

As shown in FIG. 1C and by reference number 125, the identifier manager may transmit, and the user device may receive, instructions for a UI that includes a second input element (e.g., at least one second input element) for indicating a set of restrictions (e.g., at least one restriction). The identifier manager may transmit, and the user device may receive, the instructions for the UI in response to the request received in connection with reference number 110 and/or the indication of the target user received in connection with reference number 120. The UI may be as described in connection with FIG. 2C. Accordingly, the user device may receive an indication of the set of restrictions (e.g., from the user of the user device) using the UI. For example, the user may interact with a text box (e.g., as described in connection with FIG. 2C) to input the indication of the set of restrictions (e.g., an expiry datetime, an approved category, an approved merchant, and/or a maximum amount, among other examples). Therefore, the user device may transmit, and the identifier manager may receive, the indication of the set of restrictions, as shown by reference number 130. The indication may be included in an HTTP message and/or as an argument to an API call.

Although the example 100 is described using a sequence of messages between the user device and the identifier manager, other examples may include the user device transmitting, and the identifier manager receiving, a request for the virtual identifier that indicates an intended user for the virtual identifier, the permanent identifier to be associated with the virtual identifier, and the set of restrictions to apply the virtual identifier. For example, the user device may output the UIs described above in sequence to cache (or otherwise store) the permanent identifier, the indication of the intended user, and the indication of the set of restrictions for transmitting to the identifier manager in a single request (or other message). In some implementations, the user device may use a final UI (e.g., as described in connection with FIG. 2D) to receive input that triggers the user device to transmit the single request. For example, the user may interact with a button (e.g., as described in connection with FIG. 2D) to provide the input. The single request may be a request to provide the virtual identifier, with the restriction, to the target user (also referred to as “the intended user”), as described below in connection with FIG. 1F.

As shown in FIG. 1D and by reference number 135, the identifier manager may generate the virtual identifier. The identifier manager may generate the virtual identifier in response to the request from the user device (e.g., as described above). In some implementations, the identifier manager may generate (or obtain) the virtual identifier by applying an algorithmic formula to the permanent identifier. Additionally, or alternatively, the identifier manager may generate the virtual identifier by generating numbers (e.g., one or more numbers) pseudorandomly and combining the generated numbers with fixed numbers (e.g., one or more fixed numbers) to form the virtual identifier. For example, the fixed numbers may include an indicator that the virtual identifier is virtual (and not permanent) and/or an indication of a card network associated with the virtual identifier, among other examples.

As shown by reference number 140, the identifier manager may transmit, and the account manager may receive, the virtual identifier for association with the permanent identifier. Therefore, the account manager may authorize future requests associated with the virtual identifier (e.g., by detokenizing the virtual identifier to the permanent identifier).

As further shown by reference number 140, the identifier manager may transmit, and the account manager may receive, an indication of the set of restrictions for association with the virtual identifier. Therefore, the account manager may authorize future requests, associated with the virtual identifier, only if the set of restrictions is satisfied.

Although the example 100 depicts the identifier manager as separate from the account manager, other examples may include the account manager as at least partially integrated (e.g., virtually, logically, and/or physically) with the identifier manager. Therefore, operations described herein as performed by the account manager may be performed by the identifier manager.

As shown by reference number 145, the identifier manager may transmit, and the mobile receiving device may receive, a hyperlink associated with the virtual identifier. The hyperlink may be a uniform resource identifier (URI) (e.g., a uniform resource locator (URL)) that triggers an application executed by the mobile receiving device. The identifier manager may include the hyperlink in a text message, an email message, and/or a push notification, among other examples.

In some implementations, the identifier manager may determine the mobile receiving device based on the target user. For example, the identifier manager may map an indicator of the intended user (e.g., included in the request, or another type of indication, from the user device) to an identifier of the mobile receiving device. The identifier manager may map a name of the user and/or a username of the user to an Internet protocol (IP) address associated with the mobile receiving device and/or a medium access control (MAC) address associated with the mobile receiving device. Therefore, the identifier manager may transmit the hyperlink to the mobile receiving device based on the identifier of the mobile receiving device. Alternatively, the identifier manager may transmit the hyperlink to the mobile receiving device based on the indicator of the intended user. For example, the identifier manager may directly use an email address associated with the intended user to transmit an email message with the hyperlink or may directly use a phone number associated with the intended user to transmit a text message with the hyperlink.

As shown in FIG. 1E and by reference number 150, the mobile receiving device may perform an API call using the hyperlink. Accordingly, the identifier manager may receive the API call that is based on (e.g., results from or is otherwise triggered by) the hyperlink. In some implementations, the identifier manager may receive the API call over a computer network (e.g., the Internet or an intranet, among other examples). By using the computer network to communicate, the identifier manager may reduce latency as compared with using near field communication (NFC) or another contact-based communication protocol. In some implementations, a user of the mobile receiving device may interact with the hyperlink in order to trigger the mobile receiving device to perform the API call.

As shown by reference number 155a, the identifier manager may verify the user of the mobile receiving device. The identifier manager may verify the user in response to the API call. In some implementations, the identifier manager may verify the user using a set of credentials (e.g., received with the API call). The set of credentials may include a certificate and/or a signature generated by the application executed by the mobile receiving device (and triggered by the hyperlink).

Additionally, or alternatively, as shown by reference number 155b, the authentication service may verify the user of the mobile receiving device (e.g., on behalf of the identifier manager). For example, the mobile receiving device may transmit, and the authentication service may receive, a set of credentials (e.g., a username and password, a passkey, a certificate, a signature, a private key, and/or biometric information, among other examples). Accordingly, the authentication service may verify the set of credentials and generate a data structure (e.g., a certificate and/or a signature) that verifies the set of credentials (and thus verifies the user and/or the application executed by the mobile receiving device). The authentication service may transmit, and the identifier manager may receive, the data structure such that the authentication service may verify the user using the data structure.

The identifier manager may transmit, and the mobile receiving device may receive (e.g., using the application executed by the mobile receiving device), the virtual identifier. The identifier manager may transmit, and the mobile receiving device may receive, the virtual identifier in response to (the identifier manager and/or the authentication service) verifying the user. In some implementations, the user device may receive the virtual identifier over the computer network (e.g., the Internet or an intranet, among other examples). By using the computer network to communicate the identifier manager may reduce latency as compared with using NFC or another contact-based communication protocol. The application executed by the mobile receiving device may include a digital wallet that (securely) stores the virtual identifier for use in future requests (e.g., for transactions or other events).

Additionally with, or alternatively to, the virtual identifier itself, the identifier manager may transmit, and the mobile receiving device may receive (e.g., using the application executed by the mobile receiving device), an encrypted token, as shown in FIG. 1F and by reference number 160. The encrypted token may authorize the application executed by the mobile receiving device to use the virtual identifier (e.g., in future requests for transactions or other events).

Even though (the application executed by the) the mobile receiving device is using the virtual identifier, (the application executed by the) the mobile receiving device may output a portion of the permanent identifier in order to improve a user’s experience. For example, the identifier manager may transmit, and the mobile receiving device may receive (e.g., using the application executed by the mobile receiving device), a portion of the permanent identifier. The portion of the permanent identifier may include, among other examples, a final four digits of the permanent identifier. Accordingly, (the application executed by the) the mobile receiving device may output the portion of the permanent identifier to the user (e.g., using an output component of the mobile receiving device).

By using techniques as described in connection with FIGS. 1A-1F, the identifier manager automatically transfers the virtual identifier to the mobile receiving device. As a result, latency in requesting the virtual identifier is reduced, and security is improved because the target user may be verified before the virtual identifier is transferred. Therefore, computer resources are conserved that otherwise would have been spent in undoing any fraudulent events (e.g., transactions) performed using the virtual identifier.

As indicated above, FIGS. 1A-1F are provided as an example. Other examples may differ from what is described with regard to FIGS. 1A-1F.

FIGS. 2A, 2B, 2C, and FIG. 2D are diagrams of example UIs 200, 220, 240, and 260, respectively, associated with requesting a virtual identifier. The example UIs 200, 220, 240, and/or 260 may be output by (an output component of) a user device based on instructions received from an identifier manager. These devices are described in more detail in connection with FIGS. 3 and 4.

As shown in FIG. 2A, the example UI 200 may include a plurality of links (or other types of interactive elements). For example, the example UI 200 includes a link 201, a link 203, a link 205, a link 207, and a link 209. Other examples may include fewer links (e.g., four links, three links, and so on) or additional links (e.g., six links, seven links, and so on). The example UI 200 may be associated with a permanent identifier. For example, the identifier manager may transmit instructions for, and the user device may output, the example UI 200 in response to (the identifier manager) verifying a set of credentials associated with the permanent identifier. One of the links may trigger a process for generating a virtual identifier associated with the permanent identifier. In FIG. 2A, the link 209 may trigger the process.

As shown in FIG. 2B, the example UI 220 may include a button 221 (or another type of interactive element) that triggers termination of the process for generating the virtual identifier. As further shown in FIG. 2B, the example UI 220 may include a set of radio buttons 223 that allow a user to select the process for generating the virtual identifier (rather than, for example, a process for adding an authorized user and/or generating a secondary permanent identifier associated with the permanent identifier). The identifier manager may transmit instructions for, and the user device may output, the example UI 220 in response to interaction with the link 209, as described in connection with FIG. 2A. The example UI 220 may further include a button 225 (or another type of interactive element) that triggers continuation of the process for generating the virtual identifier (e.g., by triggering the user device to transmit a request to the identifier manager or at least prompt a user for an intended user, as described in connection with FIG. 2C).

As shown in FIG. 2C, the example UI 240 may include a button 241 (or another type of interactive element) that triggers termination of the process for generating the virtual identifier. As further shown in FIG. 2C, the example UI 240 may include a plurality of text boxes (or other types of interactive elements). For example, the example UI 240 includes a text box 243 associated with a first name of the intended user, a text box 245 associated with a last name of the intended user, a text box 247 associated with a phone number of the intended user, and a text box 249 associated with an email address of the intended user. Other examples may include text boxes associated with different indicators of the intended user, fewer text boxes (e.g., three text boxes, two text boxes, or a single text box), or additional text boxes (e.g., five text boxes, six text boxes, and so on). As further shown in FIG. 2C, the example UI 240 may include a text box 251 (or other types of interactive elements) associated with an expiry datetime for the virtual identifier. Other examples may include a text box associated with a different restriction and/or additional text boxes (e.g., two text boxes, three text boxes, and so on). The identifier manager may transmit instructions for, and the user device may output, the example UI 240 in response to interaction with the button 225, as described in connection with FIG. 2B. The example UI 240 may further include a button 253 (or another type of interactive element) that triggers continuation of the process for generating the virtual identifier (e.g., by triggering the user device to transmit an indication of the intended user and an indication of the expiry datetime to the identifier manager or at least prompt a user for confirmation, as described in connection with FIG. 2D).

As shown in FIG. 2D, the example UI 260 may include a button 261 (or another type of interactive element) that triggers termination of the process for generating the virtual identifier. The example UI 260 may indicate the target user and the expiry datetime (e.g., from the example UI 240). The identifier manager may transmit instructions for, and the user device may output, the example UI 260 in response to interaction with the button 253, as described in connection with FIG. 2C. The example UI 260 may further include a button 263 (or another type of interactive element) that triggers continuation of the process for generating the virtual identifier (e.g., by triggering the user device to transmit a request for the virtual identifier to the identifier manager).

By using the example UIs as described in connection with FIGS. 2A-2D, latency in requesting the virtual identifier is reduced, and flexibility is increased (e.g., over websites that only offer an ability to add an authorized user and not generate a temporary virtual identifier).

As indicated above, FIGS. 2A-2D are provided as examples. Other examples may differ from what is described with regard to FIGS. 2A-2D.

FIG. 3 is a diagram of an example environment 300 in which systems and/or methods described herein may be implemented. As shown in FIG. 3, environment 300 may include an identifier manager 301, which may include one or more elements of and/or may execute within a cloud computing system 302. The cloud computing system 302 may include one or more elements 303-312, as described in more detail below. As further shown in FIG. 3, environment 300 may include a network 320, a user device 330, an account manager 340, an authentication service 350, and/or a mobile receiving device 360. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the identifier manager 301 may include one or more elements 303-312 of the cloud computing system 302, may execute within the cloud computing system 302, and/or may be hosted within the cloud computing system 302, in some implementations, the identifier manager 301 may not be cloud-based (e.g., may be implemented outside of a cloud computing system) or may be partially cloud-based. For example, the identifier manager 301 may include one or more devices that are not part of the cloud computing system 302, such as device 400 of FIG. 4, which may include a standalone server or another type of computing device. The identifier manager 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The user device 330 may include one or more devices capable of receiving, generating, storing, processing, and/or providing information associated with virtual identifiers, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 330 may communicate with one or more other devices of environment 300, as described elsewhere herein.

The account manager 340 may include one or more devices capable of processing, authorizing, and/or facilitating an event (e.g., a transaction). For example, the account manager 340 may include one or more servers and/or computing hardware (e.g., in a cloud computing environment or separate from a cloud computing environment) configured to receive and/or store information associated with processing an electronic event. The account manager 340 may process an event, such as to approve (e.g., permit, authorize, or the like) or decline (e.g., reject, deny, or the like) the event and/or to complete the event if the event is approved. The account manager 340 may be associated with a financial institution (e.g., a bank, a lender, a credit card company, or a credit union). For example, the account manager 340 may be associated with an issuing bank and/or an acquiring bank (or merchant bank). The account manager 340 may communicate with one or more other devices of environment 300, as described elsewhere herein.

The authentication service 350 may include one or more devices capable of receiving, generating, storing, processing, providing, and/or routing information associated with authentication, as described elsewhere herein. The authentication service 350 may include a communication device and/or a computing device. For example, the authentication service 350 may include a server, such as an application server, a client server, a web server, a database server, a host server, a proxy server, a virtual server (e.g., executing on computing hardware), or a server in a cloud computing system. In some implementations, the authentication service 350 may include computing hardware used in a cloud computing environment. The authentication service 350 may provide an Open Authorization (OAuth) service (e.g., for the identifier manager 301 and/or the user device 330). The authentication service 350 may communicate with one or more other devices of environment 300, as described elsewhere herein.

The mobile receiving device 360 may include one or more devices capable of receiving, generating, storing, processing, and/or providing information associated with virtual identifiers, as described elsewhere herein. The mobile receiving device 360 may include a communication device and/or a computing device. For example, the mobile receiving device 360 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The mobile receiving device 360 may execute a digital wallet application or another similar type of application, as described herein. The mobile receiving device 360 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with requesting and providing virtual identifiers. The device 400 may correspond to a user device 330, an account manager 340, an authentication service 350, and/or a mobile receiving device 360. In some implementations, a user device 330, an account manager 340, an authentication service 350, and/or a mobile receiving device 360 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

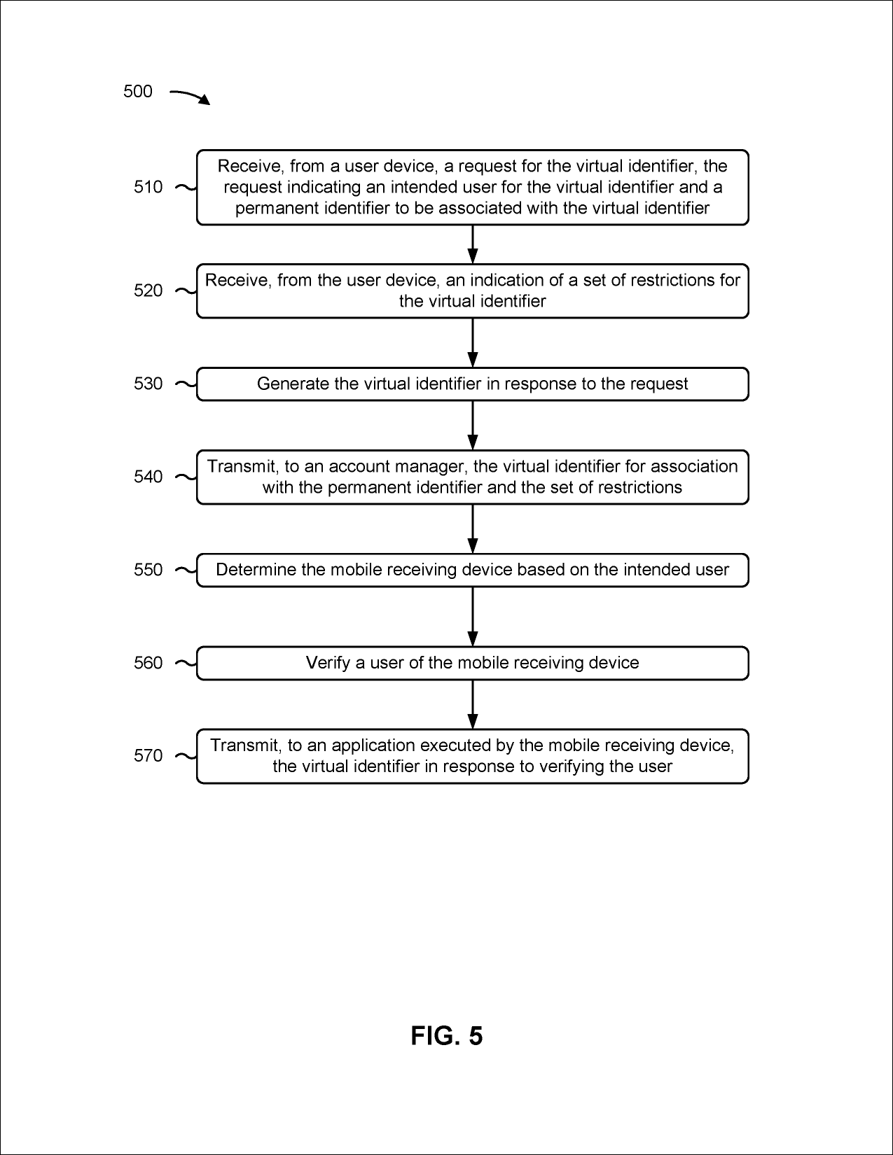

FIG. 5 is a flowchart of an example process 500 associated with providing virtual identifiers to mobile devices. In some implementations, one or more process blocks of FIG. 5 may be performed by an identifier manager 301. In some implementations, one or more process blocks of FIG. 5 may be performed by another device or a group of devices separate from or including the identifier manager 301, such as a user device 330, an account manager 340, an authentication service 350, and/or a mobile receiving device 360. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a user device, a request for the virtual identifier, the request indicating an intended user for the virtual identifier and a permanent identifier to be associated with the virtual identifier (block 510). For example, the identifier manager 301 (e.g., using processor 420, memory 430, and/or communication component 460) may receive, from a user device, a request for the virtual identifier, the request indicating an intended user for the virtual identifier and a permanent identifier to be associated with the virtual identifier, as described above in connection with FIGS. 1A-1B. As an example, the identifier manager 301 may transmit instructions for one or more UIs (e.g., as described in connection with FIGS. 2A-2D), and the identifier manager 301 may receive the request using the UI(s).

As further shown in FIG. 5, process 500 may include receiving, from the user device, an indication of a set of restrictions for the virtual identifier (block 520). For example, the identifier manager 301 (e.g., using processor 420, memory 430, and/or communication component 460) may receive, from the user device, an indication of a set of restrictions for the virtual identifier, as described above in connection with FIG. 1C. As an example, the identifier manager 301 may transmit instructions for one or more UIs (e.g., as described in connection with FIGS. 2C-2D), and the identifier manager 301 may receive the indication using the UI(s).

As further shown in FIG. 5, process 500 may include generating the virtual identifier in response to the request (block 530). For example, the identifier manager 301 (e.g., using processor 420 and/or memory 430) may generate the virtual identifier in response to the request, as described above in connection with reference number 135 of FIG. 1D. As an example, the identifier manager 301 may generate the virtual identifier by applying an algorithmic formula to the permanent identifier. Additionally, or alternatively, the identifier manager 301 may generate the virtual identifier by generating one or more numbers pseudorandomly and combining the generated number(s) with one or more fixed numbers to form the virtual identifier.

As further shown in FIG. 5, process 500 may include transmitting, to an account manager, the virtual identifier for association with the permanent identifier and the set of restrictions (block 540). For example, the identifier manager 301 (e.g., using processor 420, memory 430, and/or communication component 460) may transmit, to an account manager, the virtual identifier for association with the permanent identifier and the set of restrictions, as described above in connection with reference number 140 of FIG. 1D. As an example, the account manager may thus use the virtual identifier (and the set of restrictions) to authorize future requests associated with the virtual identifier (e.g., by detokenizing the virtual identifier to the permanent identifier).

As further shown in FIG. 5, process 500 may include determining the mobile receiving device based on the intended user (block 550). For example, the identifier manager 301 (e.g., using processor 420 and/or memory 430) may determine the mobile receiving device based on the intended user, as described above in connection with FIG. 1D. As an example, the identifier manager 301 may map a name of the user and/or a username of the user to an IP address associated with the mobile receiving device and/or a MAC address associated with the mobile receiving device. Additionally, or alternatively, the identifier manager 301 may directly use an email address associated with the user and/or a phone number associated with the user.

As further shown in FIG. 5, process 500 may include verifying a user of the mobile receiving device (block 560). For example, the identifier manager 301 (e.g., using processor 420, memory 430, and/or communication component 460) may verify a user of the mobile receiving device, as described above in connection with reference number 155a or reference number 155b of FIG. 1E. As an example, the identifier manager 301 may verify the user using a set of credentials (e.g., received from the mobile receiving device with an API call). Additionally, or alternatively, an authentication service may verify the user of the mobile receiving device (e.g., on behalf of the identifier manager 301). .

As further shown in FIG. 5, process 500 may include transmitting, to an application executed by the mobile receiving device, the virtual identifier in response to verifying the user (block 570). For example, the identifier manager 301 (e.g., using processor 420, memory 430, and/or communication component 460) may transmit, to an application executed by the mobile receiving device, the virtual identifier in response to verifying the user, as described above in connection with FIG. 1F. As an example, the identifier manager 301 may transmit the virtual identifier (and/or an encrypted token associated with the virtual identifier) for use by the application (e.g., a digital wallet application).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1F and/or FIGS. 2A-2D. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

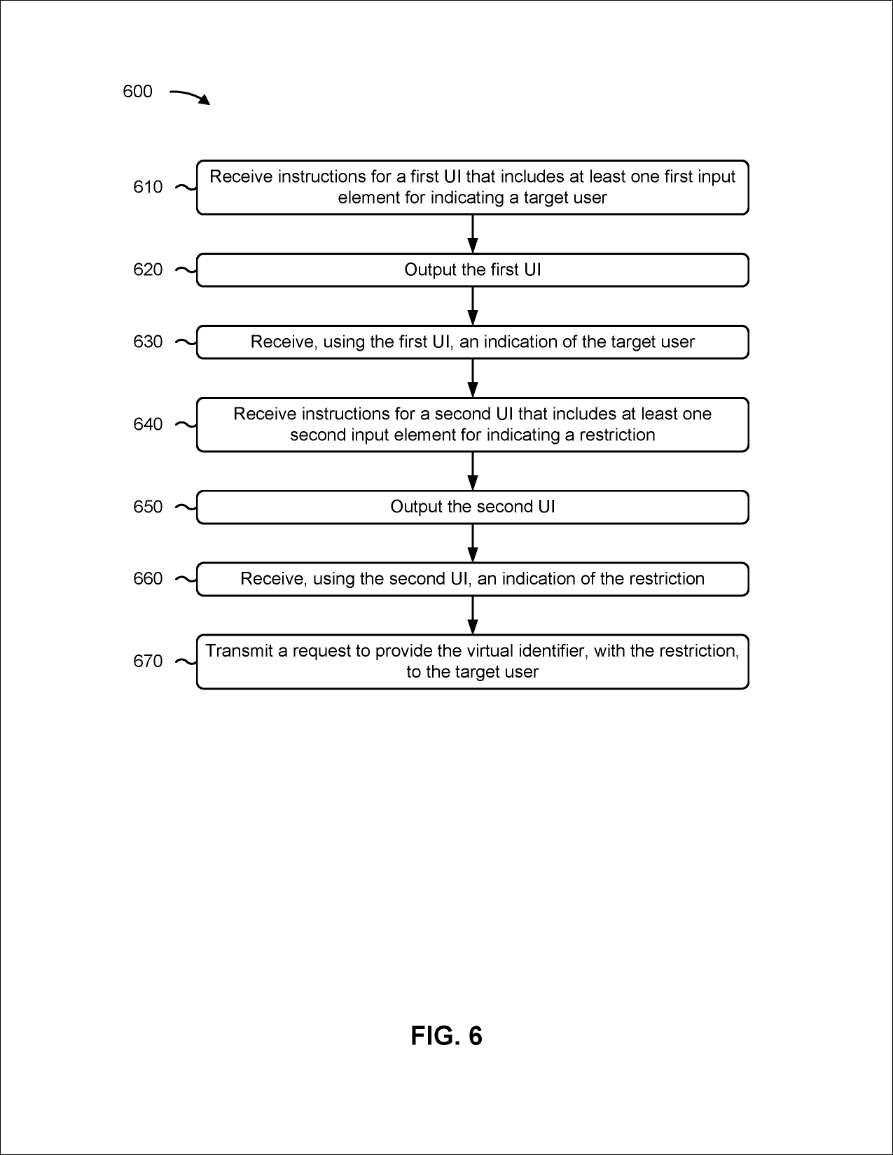

FIG. 6 is a flowchart of an example process 600 associated with requesting a virtual identifier. In some implementations, one or more process blocks of FIG. 6 may be performed by a user device 330. In some implementations, one or more process blocks of FIG. 6 may be performed by another device or a group of devices separate from or including the user device 330, such as an identifier manager, an account manager 340, an authentication service 350, and/or a mobile receiving device 360. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include receiving instructions for a first UI that includes at least one first input element for indicating a target user (block 610). For example, the user device 330 (e.g., using processor 420, memory 430, and/or communication component 460) may receive instructions for a first UI that includes at least one first input element for indicating a target user, as described above in connection with reference number 115 of FIG. 1B. As an example, the first UI may be as described in connection with FIG. 2C.

As further shown in FIG. 6, process 600 may include outputting the first UI (block 620). For example, the user device 330 (e.g., using processor 420, memory 430, and/or output component 450) may output the first UI, as described above in connection with FIG. 1B.

As further shown in FIG. 6, process 600 may include receiving, using the first UI, an indication of the target user (block 630). For example, the user device 330 (e.g., using processor 420, memory 430, and/or input component 440) may receive, using the first UI, an indication of the target user, as described above in connection with FIG. 1B. As an example, the indication of the target user may include a name, a username, an email address, and/or a phone number.

As further shown in FIG. 6, process 600 may include receiving instructions for a second UI that includes at least one second input element for indicating a restriction (block 640). For example, the user device 330 (e.g., using processor 420, memory 430, and/or communication component 460) may receive instructions for a second UI that includes at least one second input element for indicating a restriction, as described above in connection with reference number 125 of FIG. 1C. As an example, the second UI may be as described in connection with FIG. 2C.

As further shown in FIG. 6, process 600 may include outputting the second UI (block 650). For example, the user device 330 (e.g., using processor 420, memory 430, and/or output component 450) may output the second UI, as described above in connection with FIG. 1C.

As further shown in FIG. 6, process 600 may include receiving, using the second UI, an indication of the restriction (block 660). For example, the user device 330 (e.g., using processor 420, memory 430, and/or input component 440) may receive, using the second UI, an indication of the restriction, as described above in connection with FIG. 1C. As an example, the restriction may include an expiry datetime, an approved category, an approved merchant, and/or a maximum amount.

As further shown in FIG. 6, process 600 may include transmitting a request to provide the virtual identifier, with the restriction, to the target user (block 670). For example, the user device 330 (e.g., using processor 420, memory 430, and/or communication component 460) may transmit a request to provide the virtual identifier, with the restriction, to the target user, as described above in connection with FIGS. 1A-1C. As an example, the request may include an HTTP request and/or an API call. The user device 330 may transmit the request to an identifier manager. The request may include the indication of the target user and the indication of the restriction.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1F and/or FIGS. 2A-2D. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for providing a virtual identifier to a mobile receiving device, the system comprising:
one or more memories; and
one or more processors, communicatively coupled to the one or more memories, configured to:
receive, from a user device, a request for the virtual identifier, the request indicating an intended user for the virtual identifier and a permanent identifier to be associated with the virtual identifier;
receive, from the user device, an indication of a set of restrictions for the virtual identifier;
generate the virtual identifier in response to the request;
transmit, to an account manager, the virtual identifier for association with the permanent identifier and the set of restrictions;
determine the mobile receiving device based on the intended user;
transmit, to the mobile receiving device, a hyperlink associated with the virtual identifier;
receive, from the mobile receiving device and over a computer network, an application programming interface (API) call using the hyperlink;
verify a user of the mobile receiving device using a set of credentials received with the API call; and
transmit, to an application executed by the mobile receiving device and over the computer network, the virtual identifier in response to verifying the user.

2. The system of claim 1, wherein the one or more processors are configured to:
receive, from the user device, a set of credentials associated with the permanent identifier; and
verify the set of credentials associated with the permanent identifier,
wherein the one or more processors, to receive the request for the virtual identifier, are configured to receive the request for the virtual identifier based on verifying the set of credentials.

3. The system of claim 1, wherein the one or more processors, to determine the mobile receiving device, are configured to:
map an indicator of the intended user for the virtual identifier, included in the request, to an identifier of the mobile receiving device.

4. The system of claim 1, wherein the one or more processors, to transmit the virtual identifier in response to verifying the user, are configured to:
transmit an encrypted token that authorizes the application executed by the mobile receiving device to use the virtual identifier.

5. The system of claim 1, wherein the set of credentials received with the API call comprises a certificate or a signature generated by the application executed by the mobile receiving device.

6. The system of claim 1, wherein the set of restrictions includes an expiry datetime, an approved category, an approved merchant, or a maximum amount.

7. The system of claim 1, wherein the hyperlink comprises a uniform resource identifier (URI) that triggers the application executed by the mobile receiving device.

8. The system of claim 1, wherein the computer network comprises an intranet or the Internet.

9. A method of providing a virtual identifier to a mobile receiving device, comprising:
receiving, from a user device, a request for the virtual identifier, the request indicating an intended user for the virtual identifier and a permanent identifier to be associated with the virtual identifier;
receiving, from the user device, an indication of a set of restrictions for the virtual identifier;
generating, by an identifier manager, the virtual identifier in response to the request;
transmitting, to an account manager, the virtual identifier for association with the permanent identifier and the set of restrictions;
determining, by the identifier manager, the mobile receiving device based on the intended user;
verifying, by the identifier manager, a user of the mobile receiving device; and
transmitting, to an application executed by the mobile receiving device, the virtual identifier in response to verifying the user.

10. The method of claim 9, further comprising:
transmitting, to the application executed by the mobile receiving device, a portion of the permanent identifier for outputting to the user of the mobile receiving device.

11. The method of claim 9, wherein transmitting the virtual identifier in response to verifying the user comprises:
transmitting an encrypted token that authorizes the application executed by the mobile receiving device to use the virtual identifier without indicating the virtual identifier.

12. The method of claim 9, further comprising:
receiving, from an authentication service, a data structure that verifies the application executed by the mobile receiving device,
wherein the user is verified using the data structure.

13. The method of claim 9, wherein generating the virtual identifier comprises:
applying an algorithmic formula to the permanent identifier to obtain the virtual identifier.

14. The method of claim 9, wherein generating the virtual identifier comprises:
generating, for the virtual identifier, one or more numbers pseudorandomly in combination with one or more fixed numbers of the virtual identifier.

15. A non-transitory computer-readable medium storing a set of instructions for requesting that a virtual identifier be sent, the set of instructions comprising:
one or more instructions that, when executed by one or more processors of a device, cause the device to:
receive instructions for a first user interface (UI) that includes at least one first input element for indicating a target user;
output the first UI;
receive, using the first UI, an indication of the target user;
receive instructions for a second UI that includes at least one second input element for indicating a restriction;
output the second UI;
receive, using the second UI, an indication of the restriction; and
transmit a request to provide the virtual identifier, with the restriction, to the target user.

16. The non-transitory computer-readable medium of claim 15, wherein the one or more instructions, when executed by the one or more processors, cause the device to:
receive input that triggers the device to transmit the request.

17. The non-transitory computer-readable medium of claim 15, wherein the one or more instructions, when executed by the one or more processors, cause the device to:
receive instructions for a third UI; and
receive input, using the third UI, that initiates a process for providing the virtual identifier,
wherein the one or more instructions, when executed by the one or more processors, cause the device to output the first UI in response to the input received using the third UI.

18. The non-transitory computer-readable medium of claim 15, wherein the at least one first input element comprises a text box, and the indication of the target user comprises an email address or a phone number.

19. The non-transitory computer-readable medium of claim 15, wherein the at least one second input element comprises a text box, and the indication of the restriction comprises an expiry datetime.

20. The non-transitory computer-readable medium of claim 15, wherein the one or more instructions, when executed by the one or more processors, cause the device to:
verify a set of credentials associated with a permanent identifier,
wherein the virtual identifier is associated with the permanent identifier.
